(19) United States
(12) Patent Application Publication
(10) Pub. No.: US 2016/0182665 A1
(43) Pub. Date: Jun. 23, 2016

(54) INFORMATION DELIVERY SYSTEM AND CLIENT TERMINAL

(71) Applicant: HONDA MOTOR CO., LTD., Tokyo (JP)

(72) Inventors: Tomoko HANDA, Utsunomiya-shi, Tochigi-ken (JP); Hiromitsu YUHARA, Utsunomiya-shi, Tochigi-ken (JP); Kazuya TAMURA, Suginami-ku, Tokyo (JP)

(21) Appl. No.: 14/910,084

(22) PCT Filed: May 29, 2014
(86) PCT No.: PCT/JP2014/064210

§ 371 Date: Feb. 4, 2016

(30) Foreign Application Priority Data
Aug. 7, 2013 (JP) 2013-164591

(51) Int. Cl. H04L 29/08; H04L 29/06

(52) U.S. Cl. CPC H04L 67/26; H04L 67/42

(57) ABSTRACT

An information delivery system, which is capable of saving a user's labor related to delivery settings or configuring beneficial settings to the user, and a client terminal are provided. The client terminal of the information delivery system displays a color selection screen that includes multiple color options associated with delivery settings for push delivery from a server to the client terminal and, after one of the color options is selected by the user, displays delivery setting confirmation screens that display delivery settings corresponding to the selected color option.

### TECHNICAL FIELD

The present invention relates to a client terminal and an information delivery system, which is equipped with the client terminal and a server that push delivers various information with respect to the client terminal.

### BACKGROUND ART

A system is known that delivers using a push technology (push delivers) various information (including content) responsive to attributes of a user with respect to a client terminal from a server. See, Japanese Laid-Open Patent Publication No. 2000-067067 (hereinafter referred to as “JP2000-067067A”) and Japanese Laid-Open Patent Publication No. 10-134076 (hereinafter referred to as “JP10-134076A”). With such a system, it is necessary for user attributes to be entered (i.e., input) into the client terminal. In JP2000-067067A, for entering the user attributes, a dialog box or the like is displayed on a client terminal 2 for directing registration of user attributes, thereby prompting the user to register the user attributes (see paragraph [0023]).

In JP 10-134076A, a user selects pre-defined keywords in which the user has interest from a keyword table, and the selected keywords are registered in a user information table 10 through an input unit 15 by the user or a system administrator (see paragraph [0025]). Further, an information acquiring computer 3 is connected through a network to an information supplying computer 1, wherein from the information acquiring computer 3, the keywords may be registered by the user in a region (keyword ID29) of the user information table 10 (see paragraph [0025]).

### SUMMARY OF INVENTION

For providing a delivery service, which is capable of satisfying a user who desires information responsive to the tastes or desires of the user, a need arises for providing a large number of delivery setting items, which correspond to the preferences or desires of the user.

However, if the delivery setting items are increased in number, the time required for the user to read and understand such items, and the effort needed for the user to judge the items and perform setting operations for such items also increases.

Further, cases occur in which it may be difficult for the content of the delivery setting items to be understood simply by observing the names of the various delivery setting items. In addition, concerning items that are not familiar to the user, it may be difficult for the user to determine the content to be set therefor. Moreover, by allowing settings to be carried out based on preconceived notions of the user in relation to the distribution setting items, there is a concern that important distribution settings may be neglected, or that the settings will not be made properly.

The present invention has been devised taking into consideration the aforementioned problems, and has the object of providing an information delivery system and a client terminal, in which beneficial delivery settings can be made by the user, or in which the effort required from the user in relation to such delivery settings can be alleviated.

An information delivery system according to the present invention is equipped with a client terminal, and a server that push delivers various information with respect to the client terminal, in which the client terminal is configured to display a color selection screen including a plurality of color options associated with delivery settings for push delivery from the server to the client terminal, and after any one of the color options has been selected by a user, display a delivery settings confirmation screen that shows the delivery settings corresponding to the selected color option. With the delivery settings confirmation screen, the delivery settings can be changed responsive to an operation of the user.

According to the present invention, delivery settings for push delivery can be input by the user selecting a color option. Therefore, it is possible to alleviate the input effort required from the user in relation to such delivery settings. In particular, it is possible to enhance user convenience when the delivery settings are first input.

Further, in the event that, among the delivery settings, there are items for which the content thereof is difficult to understand, items of which the user is unaware, or items that are mistaken by the user (e.g., items that the user has decided are unnecessary, but in actuality, such items would be of great interest to the user), it is possible for delivery settings to be made that are beneficial to the user. In particular, since the colors are information that reflect the mood of the user at that time, assuming that selection of the color options is performed at a comparatively high frequency (e.g., everyday), it is highly possible for information to be delivered that is beneficial to the user, without forcing the user to possess a deep understanding in relation to the delivery settings.

Furthermore, the colors can be used as representing the psychological state and preferences, as well as the personality of the user. Thus, by associating the colors and the delivery settings on the basis of an association using psychological knowledge between the colors and the personality or psychological state and preferences of the user, delivery settings can be realized which are more beneficial or advantageous to the user.

The delivery settings, which are selected corresponding to the color options, may include a delivery frequency at which the server push delivers the various information to the client terminal.

It is considered difficult for the user to make a snap judgment concerning the determination of what degree of delivery frequency is appropriate. According to the present invention, since the delivery frequency can be set by selection of a color option that in part reflects the personality and psychological state of the user, confusion of the user in selecting the delivery frequency, and time and trouble required for adjusting the delivery frequency can be reduced.

In addition, assuming that an association between colors and the delivery frequency is made on the basis of the psychological state, preferences or personality of the user as indicated by the colors, then by way of selecting a color, the delivery frequency can be set to fit with the psychological state, preferences or personality of the user.

In addition to the delivery settings corresponding to the selected color option, the client terminal may display on the delivery settings confirmation screen a character corresponding to the selected color option. In accordance with this feature, a character that corresponds to the color option selected by the user can be displayed on the delivery settings confirmation screen together with the delivery settings. Consequently, an incentive can be given to the user to select the color option, together with enabling confirmation of the delivery settings to be carried out in an enjoyable manner.

The delivery settings, which are selected corresponding to the color options, may include type selection settings for selecting a type of the various information that is push delivered by the server. With the delivery settings confirmation screen, the type selection settings can be changed responsive to the operation of the user, and the server may deliver to the client terminal information responsive to the type selection settings, which have been confirmed on the delivery settings confirmation screen.

According to the above feature, initial values of the type selection settings are selected responsive to the color option selected by the user. Therefore, input operations for the type selection settings can be simplified. Further, the server push delivers information responsive to the type selection settings, which have been confirmed or modified by the user on the delivery settings confirmation screen. Therefore, a push delivery (personal service) can be provided that fits with the preferences or desires of the user.

In addition, in the case that the type selection settings are carried out repeatedly corresponding to the color options, through the confirmation or modification on the delivery settings confirmation screen, type selection settings can be made in which the preferences or desires of the user are more appropriately reflected.

The client terminal may use the selected color as a background color of the delivery settings confirmation screen or a display screen that is displayed thereafter. Consequently, the color setting for the delivery settings also serves in a dual manner as a selection of the background color of the delivery settings confirmation screen or the display screen thereafter. Hence, the selection of colors for the delivery settings can be made more interesting for the user. Further, in the case that the delivery settings are carried out repeatedly corresponding to the color options, the user can enjoy a change of the background color accompanying selection of the color options.

A client terminal according to the present invention receives push delivery of various information from a server, in which the client terminal is configured to display a color selection screen including a plurality of color options associated with delivery settings for push delivery from the server to the client terminal, and after any one of the color options has been selected by a user, display a delivery settings confirmation screen that shows the delivery settings corresponding to the selected color option. With the delivery settings confirmation screen, the delivery settings can be changed responsive to an operation of the user.

### BRIEF DESCRIPTION OF DRAWINGS

FIG. 1 is a block diagram illustrating in outline the configuration of an information delivery system according to an embodiment of the present invention;

FIG. 2 is a flowchart of steps performed when a client terminal acquires a delivery settings program;

FIG. 3 is a flowchart of steps performed upon initial entry of delivery settings in the client terminal;

FIG. 4 is a view showing an example of a color selection screen;

FIG. 5 is a view showing an example of a delivery frequency confirmation screen;

FIG. 6 is a view showing an example of a various settings initial screen;

FIG. 7 is a view showing an example of a various settings confirmation screen that follows the various settings initial screen;

FIG. 8 is a view showing an example of a color selection screen as a modification of the color selection screen (FIG. 4) of the aforementioned embodiment; and

FIG. 9 is a view showing an example of a various settings confirmation screen that is displayed following the color selection screen of FIG. 8.

### DESCRIPTION OF EMBODIMENTS

### A. First Embodiment

### 1. Configuration

### (1-1. Overall Configuration)

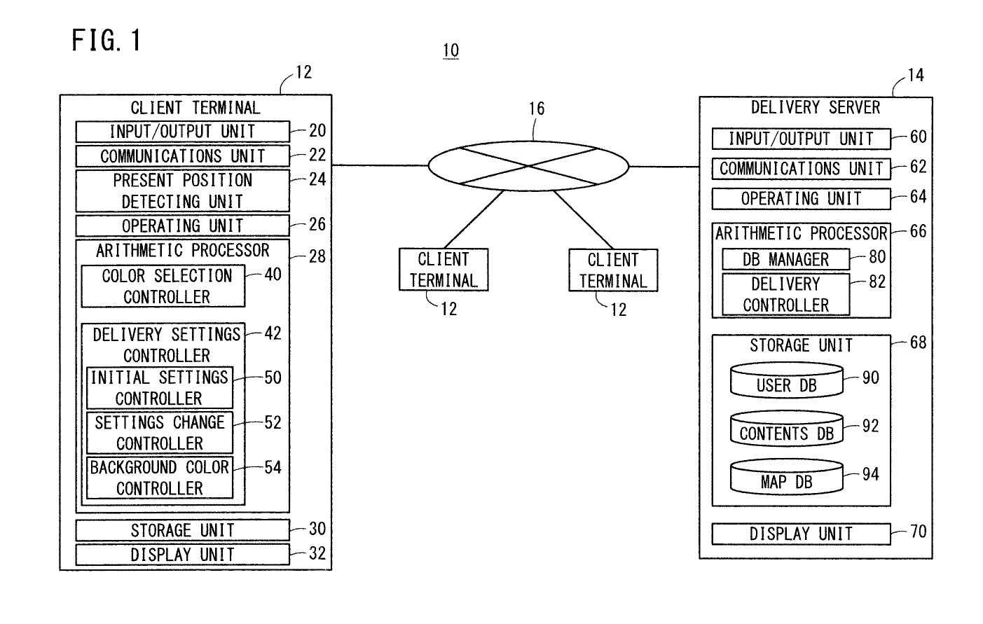

FIG. 1 is a block diagram showing an overall configuration of an information delivery system 10 (hereinafter also referred to as a “system 10”) according to an embodiment of the present invention. The system 10 is equipped with a plurality of client terminals 12 (hereinafter also referred to as “terminals 12”), and a distribution server 14 (hereinafter also referred to as a “server 14”). In the present embodiment, the server 14 and each of the client terminals 12 are capable of communicating with each other via a communications network 16.

### (1-2. Client Terminal 12)

As shown in FIG. 1, the client terminal 12 includes an input/output unit 20, a communications unit 22, a present position detecting unit 24, an operating unit 26, an arithmetic processor 28, a storage unit 30, and a display unit 32. The input/output unit 20 carries out input and output of signals in the client terminal 12. The communications unit 22 carries out communications with the server 14 via a wired or wireless network. The present position detecting unit 24 detects the present position of the terminal 12. The operating unit 26 comprises an input device such as a touch panel or the like for input of instructions from the user.

The arithmetic processor 28 controls respective components of the client terminal 12, and comprises a color selection controller 40 and a delivery settings controller 42. As will be described later, the color selection controller 40 and the delivery settings controller 42 are formed through execution of a delivery settings program Pd, for carrying out display of information on the display unit 32. The color selection controller 40 allows selection of a color by the user for the purpose of defining the delivery settings. The delivery settings controller 42 controls input or selection of the delivery settings. In this case, the delivery settings serve to carry out push delivery of various information (hereinafter referred to as “recommended information Irec”) from the server 14 to the client terminal 12.

The delivery settings controller 42 includes an initial settings controller 50, a settings change controller 52, and a background color controller 54. The initial settings controller 50 controls the initial values (initial settings) of the delivery settings. At this time, a portion of the initial settings are selected corresponding to the color selected by the user. The settings change controller 52 changes the delivery settings responsive to operations of the user. The background color controller 54 controls a background color of a delivery settings display screen, and another display screen.

The storage unit 30 stores various programs and data for control programs and the like that are used by the arithmetic processor 28. Among the various data, there is included user information of the client terminal 12. Further, among the user information, there is included user identifying information (user ID) for the purpose of specifying the user or the client terminal 12. The display unit 32 displays various screens, etc., which are used in relation to the delivery settings. If the operating unit 26 is a touch panel, the operating unit 26 and the display unit 32 can be constituted together as the same unit.

As hardware that makes up the client terminal 12, for example, a commercially available smart phone can be used.

### (1-3. Server 14)

As shown in FIG. 1, the server 14 comprises an input/output unit 60, a communications unit 62, an operating unit 64, an arithmetic processor 66, a storage unit 68, and a display unit 70. The input/output unit 60 carries out input and output of signals in the server 14. The communications unit 62 carries out communications with each of the client terminals 12 via a wired or wireless network. The operating unit 64 comprises an input device such as a keyboard for input of instructions from an administrator of the server 14.

The arithmetic processor 66 controls respective components of the server 14, and comprises a database management unit 80 (hereinafter referred to as a “DB manager 80”) and a delivery controller 82. The DB manager 80 manages a database included within the storage unit 68. The delivery controller 82 controls push delivery of various information (recommended information Irec) from the server 14 to the respective client terminals 12.

The storage unit 68 stores various programs and data for control programs and the like that are used by the arithmetic processor 66. The storage unit 68 includes a user database 90 (hereinafter referred to as a “user DB 90”), a contents database 92 (hereinafter referred to as a “contents DB 92”), and a map database 94 (hereinafter referred to as a “map DB 94”).

In the user DB 90, information (personal data) is contained in relation to users of the respective client terminals 12. As information related to users, there may be included the name, sex, birth date (age), and a user ID, for example.

In the contents DB 92, contents are contained as recommended information Irec. As examples of such content, there may be included items such as music, various news, various articles, event information, etc. The map DB 94 includes various types of map information (e.g., information of facilities, properties, etc.).

### 2. Various Controls

### (2-1. Overview)

Below, a description will be made of various controls performed in the client terminals 12 and the delivery server 14, until a point at which push delivery of recommended information Irec is carried out from the delivery server 14 with respect to a specified client terminal 12. According to the present embodiment, at first, using a client terminal 12, the user acquires (downloads and installs) the delivery settings program Pd. The delivery settings program Pd is a program for implementing delivery settings in the client terminal 12.

The delivery settings program Pd of the present embodiment is included in a personal assistant application program (hereinafter referred to as a “PAAP”) as a portion thereof. The PAAP is a program implemented by the client terminal 12 for enabling push delivery of information, as recommended information Irec to the client terminal 12, corresponding to respective attributes (personal data) of each of the users of the client terminals 12.

After the PAAP including the delivery settings program Pd is acquired, the user carries out input of delivery settings by operating the client terminal 12. When input of the delivery settings is completed, the concerned delivery settings are transmitted to the server 14. The server 14 then delivers by way of push delivery the recommended information Irec corresponding to the delivery settings received from the client terminal 12.

### (2-2. Acquisition of Delivery Settings Program Pd)

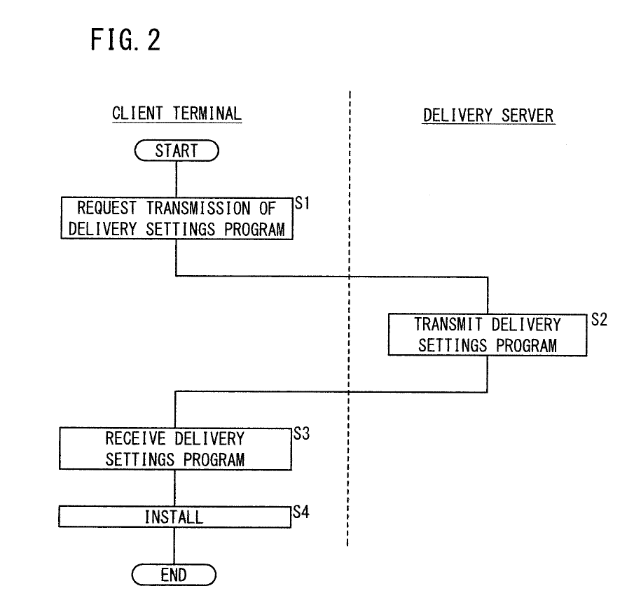

FIG. 2 is a flowchart of steps performed when the client terminal 12 acquires the delivery settings program Pd (PAAP). In step S1, in response to a user operation, the client terminal 12 issues a request to the server 14 to transmit the delivery settings program Pd (PAAP).

In step S2, responsive to the request from the client terminal 12, the server 14 transmits the delivery settings program Pd (PAAP) to the client terminal 12. The delivery settings program Pd (PAAP) is stored in the storage unit 68 of the server 14. In step S3, the client terminal 12 receives the delivery settings program Pd (PAAP), and in step S4, the client terminal 12, in response to a user operation, installs the delivery settings program Pd (PAAP).

It is not necessary that acquisition of the delivery settings program Pd (PAAP) be implemented from the server 14. For example, alternatively, the delivery settings program Pd (PAAP) can be obtained by way of online shopping via a website.

### (2-3. Input of Delivery Settings)

### (2-3-1. Initial Input of Delivery Settings)

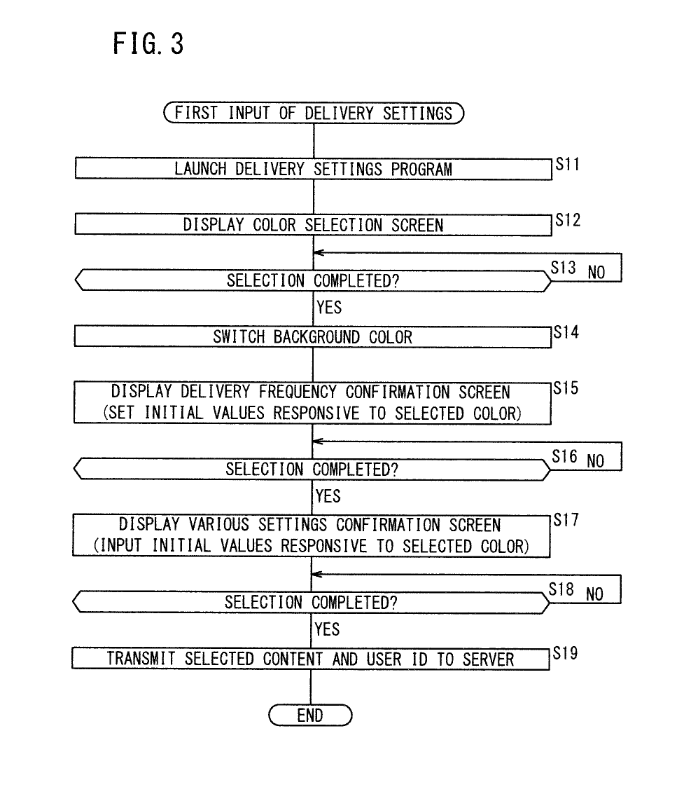

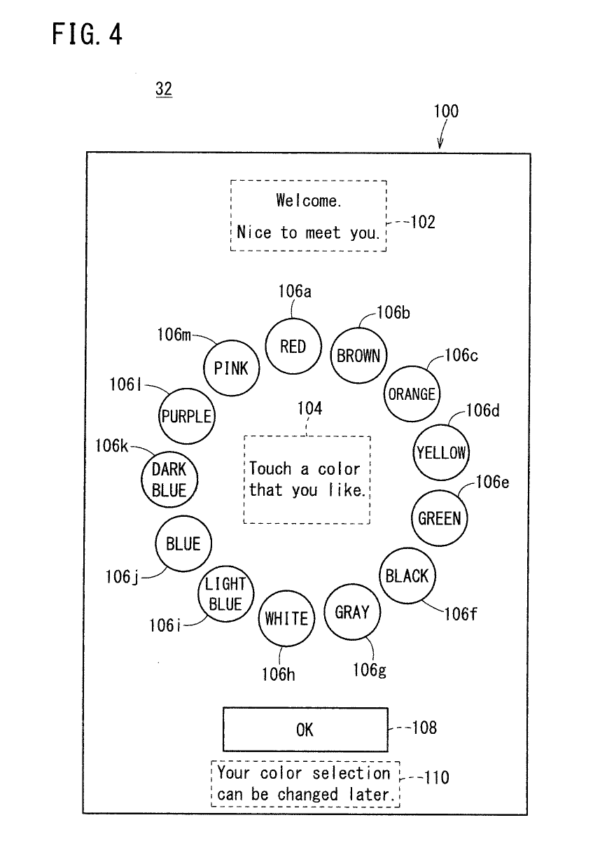

FIG. 3 is a flowchart of steps performed upon initial entry of delivery settings in the client terminal 12. In step S11, the client terminal 12 launches the delivery settings program Pd (PAAP) in response to a user operation (e.g., by the user selecting an icon). In step S12, the client terminal 12 (color selection controller 40) displays on the display unit 32 a color selection screen 100 (hereinafter also referred to as a “screen 100”), as shown in FIG. 4.

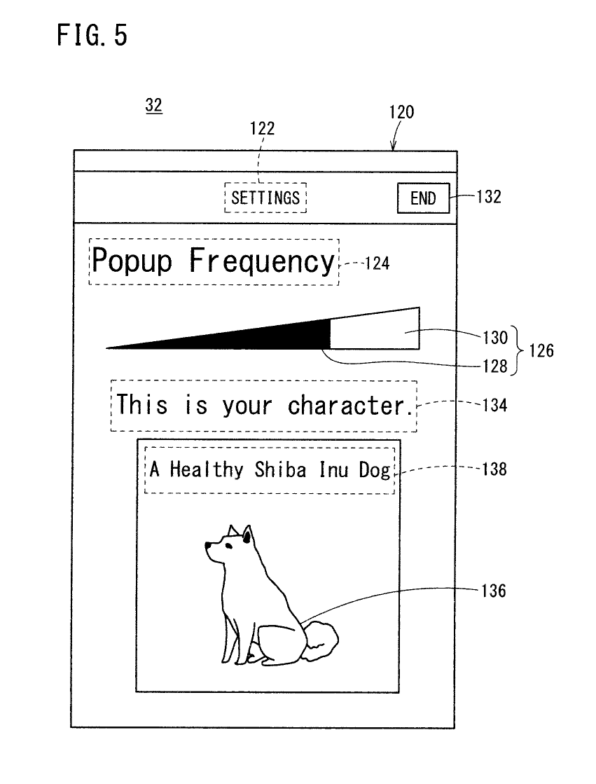

FIG. 4 is a view showing an example of the color selection screen 100. The dashed line shown in FIG. 4 indicates an imaginary line (the same applies to FIGS. 5 through 9 as well). As shown in FIG. 4, a message 102 “Welcome. Nice to meet you.” is displayed on an upper side of the screen 100. In the center of the screen 100, a message 104 “Touch a color that you like.” is displayed together with a plurality of color options (referred to as “color options 106a to 106m” and referred to collectively as “color options 106”).

According to the present embodiment, the colors of the color options 106a to 106m are red, brown, orange, yellow, green, black, gray, white, light blue, blue, dark blue, purple, and pink. More specifically, the color options 106a to 106m are displayed with colors that are shown in the centers thereof, respectively (the characters in the centers of the color options 106a to 106m are not actually shown). The respective color options 106a to 106m and are of no particular pattern and are of the same shape, and are arranged on the same circle.

At the bottom of the screen 100, an OK button 108, and a message 110 “Your color selection can be changed later.” are displayed. According to the message 104, the user selects any one of the color options 106a to 106m.

Returning to FIG. 3, in the case that none of the color options 106a to 106m has been selected (step S13: NO), step S13 is repeated. In the case that any one of the color options 106a to 106m has been selected (step S13: YES), the program proceeds to step S14.

In step S14, the client terminal 12 (background color controller 54) sets as the background color of the screen displayed on the display unit 32 a color (selected color) that corresponds to the color option 106 selected by the color selection screen 100 (step S13). In step S15, the client terminal 12 (initial settings controller 50) displays a delivery frequency confirmation screen 120 (hereinafter also referred to as a “screen 120”) (see FIG. 5).

FIG. 5 is a view showing an example of the delivery frequency confirmation screen 120. As shown in FIG. 5, at the top of the screen 120, characters 122 “Settings” are displayed as a title of the screen 120. Further, in the upper half of the screen 120, a description 124 “Popup Frequency” which implies the push delivery frequency (hereinafter referred to as the “delivery frequency Fd”) is displayed together with a slider 126 for setting the delivery frequency Fd. The delivery frequency Fd is used as a relative value assuming 100% as the highest possible push frequency.

The slider 126 includes an active region 128 and a non-active region 130. As the active region 128 becomes wider and the non-active region 130 becomes narrower, the delivery frequency Fd is indicated as being higher (greater). As the active region 128 becomes narrower and the non-active region 130 becomes wider, the delivery frequency Fd is indicated as being lower (less). By the user operating the operating unit 26 and changing the position (active scale) of the slider 126, the delivery frequency Fd (popup frequency) is adjusted. Stated otherwise, by the position (active scale) of the slider 126 being changed responsive to the operation of the user, the client terminal 12 (settings change controller 52) adjusts the delivery frequency Fd (popup frequency).

According to the present embodiment, the client terminal 12 (initial settings controller 50) sets an initial value for the delivery frequency Fd (i.e., respective widths of the active region 128 and the non-active region 130) on the screen 120, responsive to the color option 106 (selected color) (step S13 of FIG. 3) selected on the color selection screen 100. For example, in the case that the selected color is a bright color such as red, orange, yellow, or the like, the delivery frequency Fd is set higher, whereas if the selected color is a dark color such as purple, dark blue, blue, or the like, the delivery frequency Fd is set lower. More specifically, in the case that the selected color is one of red, yellow, orange, brown, green, pink, white, gray, black, light blue, blue, dark blue, and purple, the delivery frequencies Fd are set to 90%, 90%, 80%, 80%, 70%, 50%, 50%, 50%, 50%, 50%, 40%, 20%, and 10%, respectively.

On the right upper portion of the screen 120, there is displayed a completion button 132, which indicates completion of the setting (selection) of the delivery frequency Fd.

In the lower half portion of the screen 120, a character 136 and a name 138 of the character 136 are displayed together with a phrase 134, “This is your character.” The character 136 and the name 138 are selected corresponding to the color option 106 selected on the color selection screen 100 (step S13 of FIG. 3).

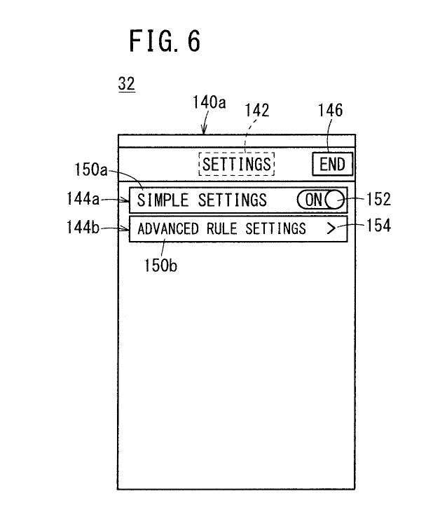

In the case that the completion button 132 is not pressed and selection of the delivery frequency Fd is not completed (step S16: NO), step S16 is repeated. In the case that the completion button 132 is pressed and selection of the delivery frequency Fd is completed (step S16: YES), then in step S17, the client terminal 12 (initial settings controller 50) displays on the display unit 32 the first of the various settings confirmation screens 140a (hereinbelow also referred to as a “various settings initial screen 140a”, an “initial screen 140a” or a “screen 140a”) (see FIG. 6).

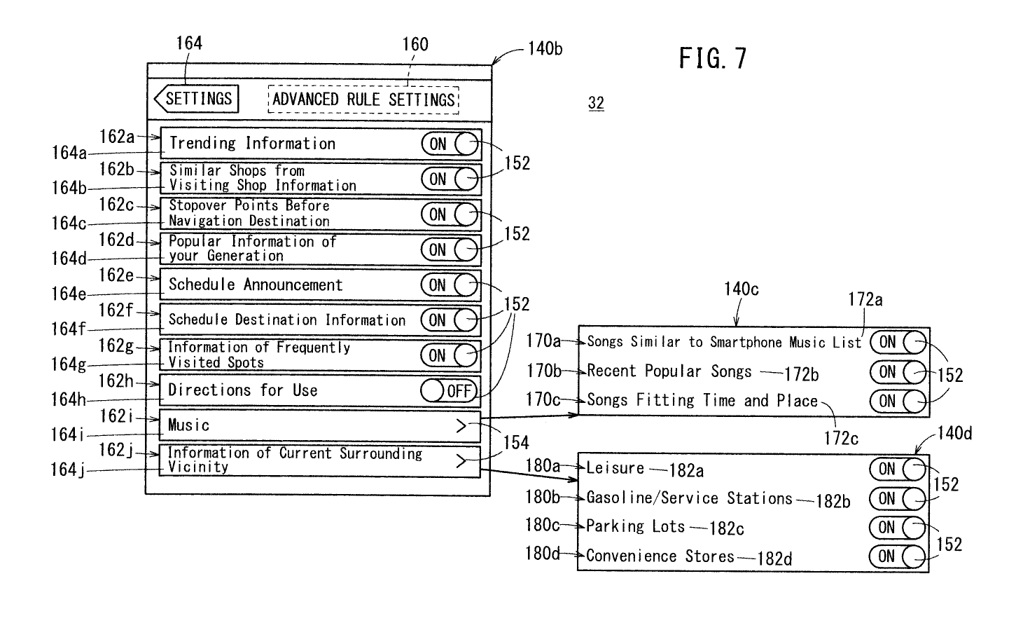

In FIG. 6, an example of the various settings initial screen 140a is shown, and in FIG. 7, examples of various settings confirmation screens 140b to 140d (hereinafter also referred to as “screens 140b to 140d”), which are displayed following the various settings initial screen 140a, are shown. Hereinafter, the screens 140a to 140d may be referred to collectively as various settings confirmation screens 140. Further, it should be noted that, in FIG. 7, only portions of the screens 140c, 140d are shown.

As shown in FIG. 6, on the initial screen 140a, there are displayed characters 142 “SETTINGS” as a title of the screen 140a, setting items 144a, 144b, and a completion button 146.

The setting item 144a includes characters 150a “SIMPLE SETTINGS” indicative of the content thereof, and an ON/OFF button 152 arranged to the right of the characters 150a. By operating the button 152, the user of the client terminal 12 can turn the simple settings on or off. The simple settings item is a setting for automatically selecting the delivery settings corresponding to the selected color option 106 (step S13 of FIG. 3).

According to the present embodiment, in the case that initial settings of the color options 106 are to be carried out, the simple settings item is turned ON. In addition, setting items are included by which various settings are carried out responsive to the selected color option 106.

Further, the setting item 144b includes characters 150b “ADVANCED RULE SETTINGS” indicative of the content thereof, and a right angle bracket 154 arranged to the right of the characters 150b. When the right angle bracket 154 is touched, the next various settings confirmation screen 140b is displayed (see FIG. 7).

With the screen 140b, delivery setting items are set, which differ from the setting items selected on the delivery frequency confirmation screen 120 or the initial screen 140a. More specifically, on the screen 140b, there are displayed characters 160 “ADVANCED RULE SETTINGS” as a title of the initial screen 140b, setting items 162a to 162j, and a return button 164. Moreover, although on the screen 140b, the setting items 162a to 162j are displayed, by scrolling the screen 140b up and down, other setting items can also be displayed.

The setting items 162a to 162j include characters 164a to 164j indicative of the content for each of the setting items. Further, the setting items 162a to 162h include ON/OFF buttons 152 arranged to the right of the characters 164a to 164h. By operating the buttons 152 through the operating unit 26 (e.g., touch panel), the user of the client terminal 12 can turn each of the settings on or off.

The setting items 162i, 162j include right angle brackets 154 arranged to the right of the characters 164i, 164j. When the user touches the right angle bracket 154 to the right of the characters 164i, the screen 140c (music settings screen) is displayed. The screen 140c includes setting items 170a to 170c. The setting items 170a to 170c include characters 172a to 172c, and ON/OFF buttons 152.

Further, when the user touches the right angle bracket 154 to the right of the characters 164j, the screen 140d (facility settings screen) is displayed. The screen 140d includes setting items 180a to 180d. The setting items 180a to 180d include characters 182a to 182d, and ON/OFF buttons 152.

According to the present embodiment, the setting items 162a to 162g, 162i, 162j, 170a to 170c, and 180a to 180d are switched ON or OFF responsive to the color options 106. More specifically, as shown in FIG. 7, the setting items 162a to 162g, 162i, 162j, 170a to 170c, and 180a to 180d are turned ON. This indicates that, among the color options 106, for example, the initial values (initial settings) are for a case in which the color option 106a (red) was selected. In the case that the color option 106f (black) is selected instead, the initial values for some of the setting items 162a to 162g, 162i, 162j, 170a to 170c, and 180a to 180d are set to OFF. The initial values (initial settings) responsive to the color options 106 are included in the delivery settings program Pd.

The remaining setting item 162h is fixed to OFF regardless of the color options 106.

Returning to FIG. 3, in the case that the completion button 146 on the initial screen 140a (see FIG. 6) is not pressed and selection of the respective settings is not completed (step S18: NO), step S18 is repeated. On the other hand, in the case that the completion button 146 on the initial screen 140a is pressed and selection of the respective settings is completed (step S18: YES), the program proceeds to step S19. In step S19, the client terminal 12 transmits to the server 14 the user ID as well as the selected content (i.e., the color option 106, the delivery frequency Fd, and the other delivery settings) that were selected in step S13, step S16, and step S18.

### (2-3-2. Updating of Delivery Settings)

In the event that the delivery settings are updated (i.e., if input of the delivery settings is made a second time or more), the same processing used for initial input of the delivery settings (see FIG. 3) can be carried out. In this case, the message 102 on the screen 100 (see FIG. 4) is changed to content applicable to updating of the delivery settings (for example, “Do you want to change the current color?”.

Alternatively, when the delivery settings are updated, it is possible to use a process flow, which differs from that at the time of the initial entry thereof. For example, when the delivery settings program Pd (PAAP) is started for a second time or greater, at first, a screen (delivery settings modifying screen) for modifying or confirming the delivery settings is displayed, and on such a delivery settings modification screen, options (color reselection options) are included for reselecting the color options 106a to 106m. In addition, by user selecting the color reselection options, a screen, which is the same as the screen 100 shown in FIG. 4, may be displayed. The process flow thereafter can be the same as shown in FIG. 3.

### (2-4. Registration by Server 14)

When the server 14 receives the selected content and the user ID that are sent from the client terminal 12 (step S19 of FIG. 3), the server 14 stores the selected content in association with the user ID in the user DB 90 (see FIG. 1). If there is existing information already stored in the user DB 90, the server 14 updates the information.

(2-5. Push Delivery from Server 14 to Client Terminal 12 and Display on Client Terminal 12)

The server 14 delivers recommended information Irec by way of push delivery to the client terminal 12, corresponding to the stored delivery settings (e.g., the delivery frequency Fd, the recommended information Irec to be transmitted, etc.). As described above, as the delivery settings, various settings are included, which are representative of the delivery frequency Fd for push delivery, etc. Consequently, responsive to such settings, the server 14 delivers the recommended information Irec by way of push delivery.

The client terminal 12 receives the recommended information Irec that is delivered from the server 14 and displays the information on the display unit 32. The timing for display of the recommended information Irec in the client terminal 12, for example, can be at the time that the recommended information Irec is received. Alternatively, an icon (recommended information display icon) labeled “Display Recommended Information” may be provided on an initial screen (main menu screen) of the display unit 32, and the recommended information Irec may be displayed when the icon is selected.

Alternatively, in the event that current position information is transmitted at a predetermined timing (e.g., at fixed time intervals) from the client terminal 12 to the server 14, the recommended information Irec can be displayed at a timing corresponding to positions where the client terminal 12 moves thereafter. For example, surrounding information (information of facilities, event information, etc.), which is information in relation to things in the vicinity of the current position of the client terminal 12, is push delivered from the server 14 to the client terminal 12 together with the position information of the concerned vicinity. Thereafter, when the client terminal 12 arrives within a predetermined distance in proximity to the concerned vicinity, the client terminal 12 displays the surrounding information.

Alternatively, the recommended information Irec can be displayed at other timings (e.g., at an optional timing that is set by the server 14 and specified by the recommended information Irec).

### 3. Advantages of the Present Embodiment

In the foregoing manner, according to the present embodiment, by the color options 106 being selected by the user (steps S12, S13 of FIG. 3), the delivery settings for push delivery can be input (step S15). Therefore, it is possible to alleviate the effort required from the user in relation to such delivery settings. In particular, it is possible to enhance user convenience when the delivery settings are first input.

Further, in the event that, among the delivery settings, there are items for which the content thereof is difficult to understand, items of which the user is unaware, or items that are mistaken by the user (e.g., items that the user has decided are unnecessary, but in actuality, such items would be of great interest to the user), it is possible for delivery settings to be made that are beneficial to the user. In particular, since the colors are information that reflect the mood of the user at that time, assuming that selection of the color options 106 is performed at a comparatively high frequency (e.g., everyday), it is highly possible for information to be delivered that is beneficial to the user, without forcing the user to possess a deep understanding in relation to the delivery settings.

Further, it is possible for a color to the used that represents the psychological state, preferences, and personality of the user. Thus, by associating the colors and the delivery settings using psychological knowledge, on the basis of an association between the colors and the psychological state, preferences, or personality of the user, delivery settings can be realized which are more beneficial or advantageous to the user.

In the present embodiment, the delivery settings, which are selected corresponding to the color options 106, include the delivery frequency Fd (refer to FIG. 5 and step S15 of FIG. 3) at which the server 14 push delivers the recommended information Irec (various information). It is considered difficult for the user to make a snap judgment concerning the determination of what degree of delivery frequency Fd is appropriate. According to the present embodiment, since the delivery frequency Fd can be set by selection of a color option 106, confusion of the user in selecting the delivery frequency Fd, and time and trouble required for adjusting the delivery frequency Fd can be reduced.

In addition, assuming that an association between the color and the delivery frequency Fd is made on the basis of the psychological state, preferences or personality of the user as indicated by the color, then by way of selecting a color, the delivery frequency Fd can be set to fit with the psychological state, preferences or personality of the user.

According to the present embodiment, in addition to the delivery settings corresponding to the selected color option 106, the client terminal 12 may display on the delivery frequency confirmation screen 120 (delivery settings confirmation screen) a character 136 corresponding to the selected color option 106 (see FIG. 5). In accordance with this feature, a character 136 that corresponds to the color option 106 selected by the user can be displayed on the screen 120 together with the delivery settings. Consequently, an incentive can be given to the user to select the color option 106, together with enabling confirmation of the delivery settings to be carried out in an enjoyable manner.

In the present embodiment, the client terminal 12 uses the selected color as a background color of the delivery frequency confirmation screen 120 (see FIG. 5), the various settings confirmation screens 140a to 140d (see FIGS. 6 and 7), and the display screens that are displayed thereafter (step S14 of FIG. 3). Consequently, the color selection for the delivery settings also serves in a dual manner as a selection of the background color for screens such as the screens 120, 140a to 140d, etc. Therefore, selection of a color for the delivery settings can be made of greater interest to the user. Further, in the case that the delivery settings are carried out repeatedly corresponding to the color options 106, the user can enjoy a change of the background color accompanying selection of the color options 106.

### B. MODIFICATIONS

The present invention is not limited to the embodiment described above. Various modified or additional configurations can be adopted based on the content disclosed in the present specification. For example, the following modified configurations can be adopted.

### 1. Client Terminal 12

In the above embodiment, the client terminal 12 comprises a smart phone. However, for example, so long as the client terminal 12 is capable of receiving various information (recommended information Irec), which is delivered from the server 14 by way of push delivery, the client terminal 12 may comprise a different type of configuration (e.g., a tablet computer, a notebook type personal computer (PC), or a desktop PC).

### 2. Delivery Settings Program Pd

In the above embodiment, the software (delivery settings program Pd) for carrying out the delivery settings is used upon being downloaded to the client terminal 12 from the server 14 (see FIG. 2). However, so long as the delivery settings are made for enabling delivery by way of push delivery from the server 14 to the client terminal 12, the manner in which the delivery settings are implemented is not limited. For example, the delivery settings may be implemented through a so-called ASP (application service provider) without downloading the delivery settings program Pd.

### 3. Color Selection Screen 100

With the above-described embodiment, the color options 106 on the color selection screen 100 are of no particular pattern and are of the same shape (see FIG. 4). However, for example, from the standpoint of selecting delivery settings responsive to the selected color option 106, without limitation, the respective color options 106 may be displayed with a pattern or of different shapes.

The above embodiment is premised on the selection of one color from among the color options 106 that are displayed on the color selection screen 100 (see FIG. 4). However, for example, from the standpoint of selecting delivery settings responsive to the selected color options 106, a configuration may be provided in which a plurality of colors are selected from among the color options 106. In this case, the delivery settings may be specified for each of combinations of the color options 106.

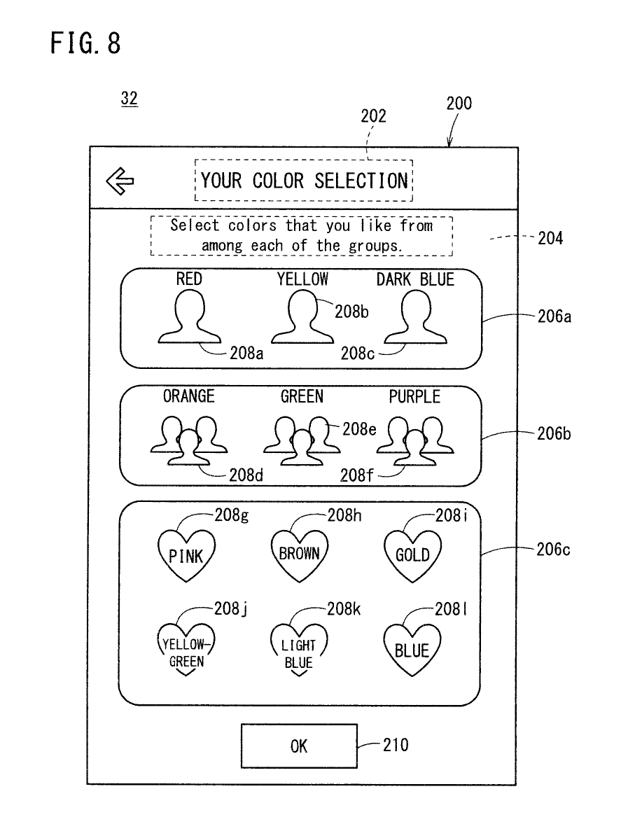

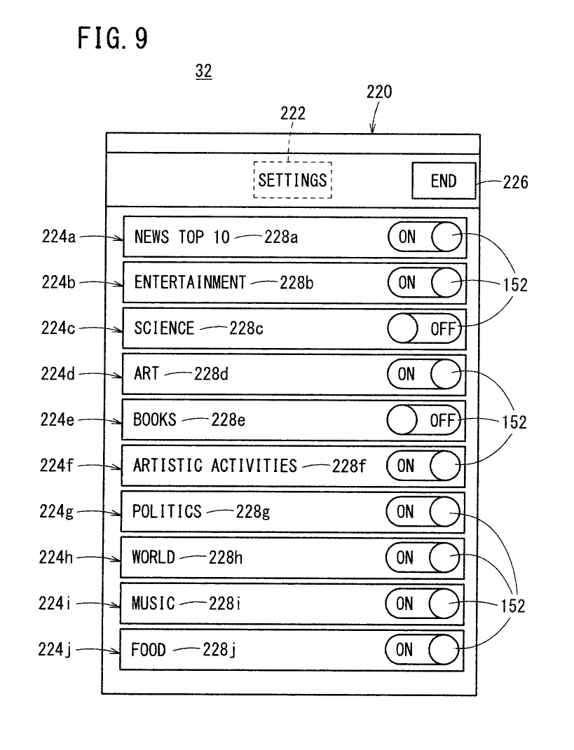

FIG. 8 is a view showing an example of a color selection screen 200 (hereinafter also referred to as a “screen 200”) as a modification of the color selection screen 100 of the aforementioned embodiment (see FIG. 4). FIG. 9 is a view showing an example of a various settings confirmation screen 220 (hereinafter also referred to as a “screen 220”) that is displayed following the color selection screen 200 of FIG. 8.

As shown in FIG. 8, a title 202 YOUR COLOR SELECTION″ is displayed on an upper side of the screen 200, and a message 204 “Select colors that you like from among each of the groups.” is displayed underneath the title 202. Furthermore, three groups (a first group 206a, a second group 206b, and a third group 206c) including color options 208a to 2081 are displayed below the message 204.

Any of the color options 208a to 208c included in the first group 206a is in the shape of an upper body of one person, and the colors of each are red, yellow, and dark blue, respectively. Any of the color options 208d to 208f included in the second group 206b is in the shape of the upper bodies of multiple persons, and the colors of each are orange, green, and purple, respectively. Any of the color options 208g to 2081 included in the third group 206c is in a heart shape, and the colors of each are pink, brown, gold, yellow-green, light blue, and blue, respectively. The respective groups 206a to 206c are classified corresponding to the delivery settings to be specified. The color options 208a to 2081 are displayed with colors that are shown corresponding thereto, respectively (characters corresponding to the color options 208a to 2081 are not actually shown). Hereinafter, the color options 208g to 2081 will be referred to collectively as color options 208.

An OK button 210 is displayed at the bottom of the screen 200. When the OK button 210 is pressed under a condition in which color options 208 in the respective groups 206a to 206c have been selected, a screen 220 is displayed in which ON and OFF states of the respective settings of setting items 224a to 224j (see FIG. 9) are selected, corresponding to the combination of the selected color options 208. Details of the screen 220 will be discussed later.

### 4. Delivery Frequency Confirmation Screen 120 and Various Settings Confirmation Screens 140a to 140d (Delivery Settings Confirmation Screens)

With the above-described embodiment, on the delivery frequency confirmation screen 120, a character 136 and a name 138 therefor are displayed corresponding to the color option 106 (see FIG. 5). However, for example, from the standpoint of selecting delivery settings responsive to the selected color option 106, the character 136 and the name 138 need not necessarily correspond to the selected color option 106. Alternatively, it is possible for such a character 136 and name 138 not to be displayed.

In the above-described embodiment, the background colors of the delivery frequency confirmation screen 120, the various settings confirmation screens 140a to 140d, and the display screens that are displayed thereafter are colors (selected colors) corresponding to the selected color option 106 (step S14 of FIG. 3). However, for example, from the standpoint of selecting delivery settings responsive to the selected color option 106, only the background color of any one of the screens 120, 140a to 140d, etc., may be a color (selected color) responsive to the selected color option 106. Alternatively, the background color of the screen 120, and the screens 140a to 140d, etc., need not be a color (selected color) that corresponds to the selected color option 106. For example, the background colors of the screen 120, and the screens 140a to 140d, etc., may be the same, regardless of color (selected color) corresponding to the selected color option 106.

According to the above-described embodiment, the delivery frequency confirmation screen 120 (FIG. 5) is displayed separately from the various settings confirmation screens 140a to 140d (FIGS. 6 and 7). However, for example, from the standpoint of selecting delivery settings responsive to the selected color option 106, the displayed content of the delivery frequency confirmation screen 120 may be included within the various settings confirmation screens 140a to 140d.

According to the above-described embodiment, the delivery settings corresponding to the selected color option 106 are displayed on the delivery frequency confirmation screen 120 (FIG. 5) or the various settings confirmation screens 140a to 140d (FIGS. 6 and 7), thereby enabling the user to confirm or modify the delivery settings. However, for example, insofar as the delivery settings are capable of being selected responsive to the selected color option 106, the delivery settings may be selected in the client terminal 12 or the server 14 responsive to the selected color option 106, without undergoing confirmation or modification on the screens 120, 140a to 140d.

In the above embodiment, the delivery frequency confirmation screen 120 is displayed (step S15) immediately after a color option 106 has been selected (step S13 of FIG. 3: YES). However, from the standpoint of enabling selection of delivery settings responsive to the selected color option 106, for example, selection of the color option 106, and display of the delivery settings confirmation screens (screens 120, 140a to 140d) corresponding thereto may be carried out after a given time interval, or with another input process inserted therebetween. For example, directly after selection of a color option 106, a personal information input screen by which the user's name, age, and address are input may be displayed, and thereafter, the delivery frequency confirmation screen 120 or the various settings confirmation screens 140a to 140d may be displayed.

In the above embodiment, the delivery settings (setting items 144a, 144b, 162a to 162j, 170a to 170c, 180a to 180d) shown on the various settings confirmation screens 140a to 140d (FIGS. 6 and 7) are provided as selectable settings. However, for example, from the standpoint of selecting delivery settings responsive to the selected color option 106, the selectable delivery settings are not limited. For example, the delivery settings are capable of being selected as shown in FIG. 9.

As shown in FIG. 9, on the various settings confirmation screen 220, there are displayed characters 222 “SETTINGS” as a title of the screen 220, setting items 224a to 224j, and a completion button 226.

The setting items 224a to 224j are settings (type selection settings) for selecting the types of recommended information Irec that is push delivered by the server 14. The setting items 224a to 224j include characters 228a to 228j indicative of the content for each of the setting items. Further, the setting items 224a to 224j include ON/OFF buttons 152 arranged to the right of the characters 228a to 228j. By operating the buttons 152, the user of the client terminal 12 can turn each of the settings on or off.

The initial values (initial settings) for the setting items 224a to 224j are selected corresponding to a combination of the selected color options 208. More specifically, the initial ON/OFF values (initial settings) for the buttons 152 of the respective setting items 224a to 224j are stored in the storage unit 30 (delivery settings program Pd) for each combination of the color options 208, and are changed corresponding to the combination of color options 208 that the user has selected. Further, using the screen 220 (confirmation screen), it is possible to modify the type selection settings responsive to operations of the user, and the server 14 delivers to the client terminal 12 recommended information Irec corresponding to the type selection settings that are confirmed on the screen 220.

According to the above feature, initial values of the type selection settings are selected responsive to the color options 208 selected by the user. Therefore, with a combination of multiple types of colors, it is possible to select the psychological state and preferences of the user, whereupon the recommended information Irec is push delivered responsive to the type selection settings, which have been confirmed or modified by the user on the screen 220. Therefore, a push delivery (personal service) can be provided that fits with the preferences or desires of the user, which have been set using a judgment result in accordance with a combination of multiple types of colors.

### 5. Information Sent from Client Terminal 12 to Server 14

In the above embodiment, specification of the delivery frequency Fd corresponding to the color option 106 is carried out in the client terminal 12, and the delivery frequency Fd is transmitted to the server 14 from the client terminal 12. However, for example, from the standpoint of setting the delivery frequency Fd responsive to the selected color option 106, the selected color option 106 may be transmitted from the client terminal 12 to the server 14, and the delivery frequency Fd may be set in the server 14. Other delivery settings apart therefrom may be handled in the same manner. More specifically, the server 14 may select delivery settings corresponding to the color option 106 that is received from the client terminal 12.

### 6. Other Features

In the above embodiment, the present invention is applied to the information delivery system 10 by which the recommended information Irec is delivered from the server 14 by way of push delivery with respect to the client terminal 12 (see FIG. 1). However, for example, insofar as settings can be input automatically responsive to the selected color option 106, the invention is not necessarily limited to this feature.

1. An information delivery system equipped with a client terminal, and a server that push delivers various information with respect to the client terminal, wherein the client terminal is configured to:
display a color selection screen including a plurality of color options associated with delivery settings for push delivery from the server to the client terminal; and
after any one of the color options has been selected by a user, display a delivery settings confirmation screen that shows the delivery settings corresponding to the selected color option;
wherein, with the delivery settings confirmation screen, the delivery settings can be changed responsive to an operation of the user.

2. The information delivery system according to claim 1, wherein the delivery settings, which are selected corresponding to the color options, include a delivery frequency at which the server push delivers the various information to the client terminal.

3. The information delivery system according to claim 1, wherein, in addition to the delivery settings corresponding to the selected color option, the client terminal is configured to display on the delivery settings confirmation screen a character corresponding to the selected color option.

4. The information delivery system according to claim 1, wherein:
the delivery settings, which are selected corresponding to the color options, include type selection settings for selecting a type of the various information that is push delivered by the server;
with the delivery settings confirmation screen, the type selection settings can be changed responsive to the operation of the user; and
the server is configured to deliver to the client terminal information responsive to the type selection settings, which have been confirmed on the delivery settings confirmation screen.

5. The information delivery system according to claim 1, wherein:
the client terminal is configured to use the selected color as a background color of the delivery settings confirmation screen or a display screen that is displayed thereafter.

6. A client terminal that receives push delivery of various information from a server, wherein the client terminal is configured to:
display a color selection screen including a plurality of color options associated with delivery settings for push delivery from the server to the client terminal; and
after any one of the color options has been selected by a user, display a delivery settings confirmation screen that shows the delivery settings corresponding to the selected color option;
wherein, with the delivery settings confirmation screen, the delivery settings can be changed responsive to an operation of the user.
